(19) United States
(12) Patent Application Publication
(10) Pub. No.: US 2013/0147089 A1
(43) Pub. Date: Jun. 13, 2013

(54) TRANSPARENT CONDUCTIVE MATERIAL, DISPERSION LIQUID, TRANSPARENT CONDUCTIVE FILM, AND METHODS FOR MANUFACTURING SAME

(71) Applicants: Hirotoshi MURAYAMA, Kanagawa-ken (JP); Hideaki Hirabayashi, Kanagawa-ken (JP); Masashi Yamage, Kanagawa-ken (JP); Tsuyoshi Noma, Kanagawa-ken (JP); Masao Kon, Kanagawa-ken (JP)

(72) Inventors: Hirotoshi MURAYAMA, Kanagawa-ken (JP); Hideaki Hirabayashi, Kanagawa-ken (JP); Masashi Yamage, Kanagawa-ken (JP); Tsuyoshi Noma, Kanagawa-ken (JP); Masao Kon, Kanagawa-ken (JP)

(21) Appl. No.: 13/710,608

(22) Filed: Dec. 11, 2012

(30) Foreign Application Priority Data
Dec. 12, 2011 (JP) 2011-271400

(51) Int. Cl. H01B 1/12

(52) U.S. Cl. CPC H01B 1/12; Y10S 977/734; Y10S 977/896; B82Y 30/00
USPC 264/293; 252/500; 558/412; 977/734; 977/896

(57) ABSTRACT

According to one embodiment, a transparent conductive material is used for a transparent conductive film. The transparent conductive material includes nanographene having a polar group at a surface of the nanographene.

### CROSS-REFERENCE TO RELATED APPLICATIONS

This application is based upon and claims the benefit of priority from the prior Japanese Patent Application No. 2011-271400, filed on Dec. 12, 2011; the entire contents of which are incorporated herein by reference.

### FIELD

Embodiments described herein relate generally to a transparent conductive, a dispersion liquid, a transparent conductive film, and methods for manufacturing the same.

### BACKGROUND

A transparent conductive film is used in electronic devices such as flat panel displays, solar cells, and touch panels.

Some of such transparent conductive films include nanocarbon, such as carbon nanotubes, as a transparent conductive material. By using a material including nanocarbon as a transparent conductive material, a transparent conductive film having high transparency and conductivity can be obtained.

However, these days further improvement in the transparency and conductivity of the transparent conductive film is desired.

### BRIEF DESCRIPTION OF THE DRAWINGS

FIG. 1 is a graph for illustrating the transparency of transparent conductive films;

FIGS. 2A and 2B are schematic diagrams for illustrating the conductivity of transparent conductive films;

FIG. 3 is a flow chart for illustrating a method for manufacturing a transparent conductive material, a method for manufacturing a dispersion liquid, and a method for manufacturing a transparent conductive film according to the embodiment; and

FIG. 4 is a graph for illustrating the production of nanographene by oxidation treatment.

### DETAILED DESCRIPTION

In general, according to one embodiment, a transparent conductive material is used for a transparent conductive film. The transparent conductive material includes nanographene having a polar group at a surface of the nanographene.

Various embodiments will be illustrated hereinafter with reference to the accompanying drawings.

For transparent conductive films used in electronic devices etc., those including nanocarbon such as carbon nanotubes are known. For example, by using a transparent conductive film including carbon nanotubes, a transparent conductive film with low electric resistance can be obtained. Since the diameter dimension of the molecular chain of the carbon nanotube is a nanometer level, a transparent conductive film with high transparency can be obtained.

However, these days further improvement in the transparency and conductivity of the transparent conductive film is desired.

The inventors' investigation shows that, by using a transparent conductive film including nanographene, conductivity and transparency can be improved as compared to transparent conductive films including carbon nanotubes.

Here, when a transparent conductive film including nanocarbon such as carbon nanotubes is manufactured, a dispersion liquid in which nanocarbon is dispersed in a medium such as water is produced, the produced dispersion liquid is applied, and the applied dispersion liquid is dried to form the transparent conductive film.

However, if nanographene is simply dispersed in a medium such as water, pieces of nanographene may aggregate to cause an in-plane distribution in the characteristics of the transparent conductive film formed. For example, transparency and conductivity may greatly vary with the in-plane position in the transparent conductive film.

Hence, when nanographene is dispersed in a medium such as water, it is necessary to improve dispersion quality.

In view of this, a transparent conductive material according to the embodiment is configured to include nanographene having a polar group at its surface. By using nanographene having a polar group at its surface, dispersion quality can be improved when the nanographene is dispersed in a medium such as water.

In this case, the polar group may be a functional group directly introduced onto the surface of nanographene (corresponding to an example of a first polar group). As such a polar group, for example, a hydroxy group, a methyl group, an aldehyde group, a carboxyl group, a nitro group, and the like directly introduced onto the surface of nanographene by performing oxidation treatment or the like may be illustrated.

As the oxidation treatment, for example, a treatment using sulfuric acid and a catalyst such as potassium permanganate, a treatment with a mixed acid solution in which sulfuric acid and nitric acid are mixed, and the like may be illustrated. For example, the oxidation treatment may be performed using at least sulfuric acid.

The polar group may be also a group obtained by directly introducing a functional group onto the surface of nanographene and substituting the functional group using a nucleophile (corresponding to an example of a second polar group). As such a polar group, for example, an amino group, a hydroxyl group, a mercapto group, an organic amino group, an alkoxy group, a cyano group, a nitromethyl group, a bis(alkoxycarbonyl)methyl group, and the like introduced by performing oxidation treatment or the like to introduce a nitro group directly onto the surface of nanographene and substituting the nitro group may be illustrated.

As the substitution using a nucleophile, the case may be illustrated where a nitro group introduced by performing oxidation treatment or the like is reduced using tin (Sn), which is a nucleophile, and concentrated hydrochloric acid and is substituted with an amino group or the like.

The dispersion quality of nanographene having a polar group may be degraded depending on the type of the medium included in the dispersion liquid, the type of a resin described later, etc. In such a case, if it is possible to change the polar group by substitution, an appropriate polar group can be selected in accordance with the type of the medium, the type of the resin, etc. Consequently, the degradation in dispersion quality due to the type of the medium, the type of the resin, etc. can be suppressed.

In the transparent conductive material according to the embodiment, a resin may be further put in as a binder for improving the strength etc. of the transparent conductive film. As the resin put into the dispersion liquid, for example, a water-soluble resin and the like may be illustrated. In this case, to ensure the transparency of the transparent conductive film, a water-soluble resin with a visible light transmittance of 80% or more may be used. A nonionic water-soluble resin may be used in order to prevent the polar group introduced into nanographene from changing. As the nonionic water-soluble resin with a visible light transmittance of 80% or more, for example, poly(ethylene oxide) and the like may be illustrated.

A dispersion liquid according to the embodiment may include a transparent conductive material according to the embodiment and a medium. In the medium included in the dispersion liquid, water included in the sulfuric acid solution and/or the nitric acid solution used for oxidation treatment, water produced by neutralization using an anion exchange resin, water added during dilution, etc. are included.

A transparent conductive film according to the embodiment may include a transparent conductive material according to the embodiment. For example, it may be a transparent conductive film in which at least one of nanographene having a polar group and an aggregate of nanographene having a polar group is dispersed. It may be also one further including a water-soluble resin such as poly(ethylene oxide). Such a transparent conductive film can be formed by, for example, applying a dispersion liquid according to the embodiment to the region where the transparent conductive film will be formed and drying the applied dispersion liquid.

Next, the transparency and conductivity of the transparent conductive film according to the embodiment are illustrated.

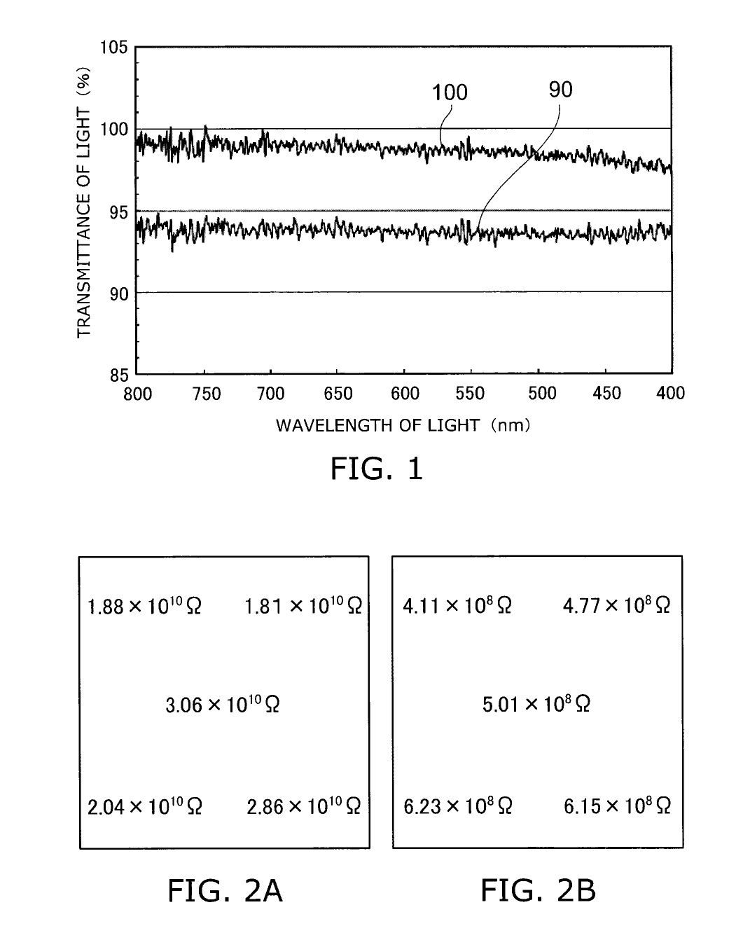

FIG. 1 is a graph for illustrating the transparency of transparent conductive films.

“90” in FIG. 1 is the case of a transparent conductive film including 5 wt % carbon nanotubes (a transparent conductive film according to a comparative example). “100” in FIG. 1 illustrates an example of the transparent conductive film according to the embodiment, and is the case of a transparent conductive film including 5 wt % nanographene having a polar group. In “90” and “100”, the other components of the transparent conductive films are mainly poly(ethylene oxide).

“90” in FIG. 1 shows the measurement results for a transparent conductive film produced by a method in which a dispersion liquid including carbon nanotubes and poly(ethylene oxide) is applied onto a glass substrate and the applied dispersion liquid is dried.

“100” in FIG. 1 shows the measurement results for a transparent conductive film produced in an example described later.

The transparency of the transparent conductive films was evaluated using the transmittance of visible light. The transmittance of visible light was measured using the spectrophotometer UV-3100 (the multipurpose large-size sample chamber MPC-3100 installation type) manufactured by Shimadzu Corporation.

As shown in FIG. 1, in the case of the transparent conductive film according to the embodiment, the transmittance of visible light can be made higher than in the case of the transparent conductive film including carbon nanotubes.

That is, the transparent conductive film according to the embodiment can improve transparency as compared to the transparent conductive film including carbon nanotubes.

FIGS. 2A and 2B are schematic diagrams for illustrating the conductivity of transparent conductive films.

FIG. 2A is a schematic diagram showing the distribution of the surface electric resistance value of a transparent conductive film including 5 wt % carbon nanotubes (a transparent conductive film according to the comparative example). FIG. 2B illustrates an example of the transparent conductive film according to the embodiment, and is a schematic diagram showing the distribution of the surface electric resistance value of a transparent conductive film including 5 wt % nanographene having a polar group.

In FIGS. 2A and 2B, the other components of the transparent conductive films are mainly poly(ethylene oxide).

FIG. 2A shows the measurement results for a transparent conductive film produced by a method in which a dispersion liquid including carbon nanotubes and poly(ethylene oxide) is applied onto a glass substrate and the applied dispersion liquid is dried.

FIG. 2B shows the measurement results for a transparent conductive film produced in the example described later.

The conductivity of the transparent conductive films was evaluated using the surface electric resistance value of the transparent conductive films. The surface electric resistance value of the transparent conductive films was measured using the Hiresta UP MCP-HT450 type manufactured by Mitsubishi Chemical Analytech Co., Ltd.

As shown in FIGS. 2A and 2B, in the case of the transparent conductive film according to the embodiment, the surface electric resistance value can be made lower than in the case of the transparent conductive film including carbon nanotubes. In this case, the average value of the surface electric resistance value of the transparent conductive film including 5 wt % carbon nanotubes was 2.33×10¹⁰Ω, and the average value of the surface electric resistance value of the transparent conductive film according to the embodiment was 5.25×10⁸Ω.

Next, a method for manufacturing a transparent conductive material, a method for manufacturing a dispersion liquid, and a method for manufacturing a transparent conductive film according to the embodiment are illustrated.

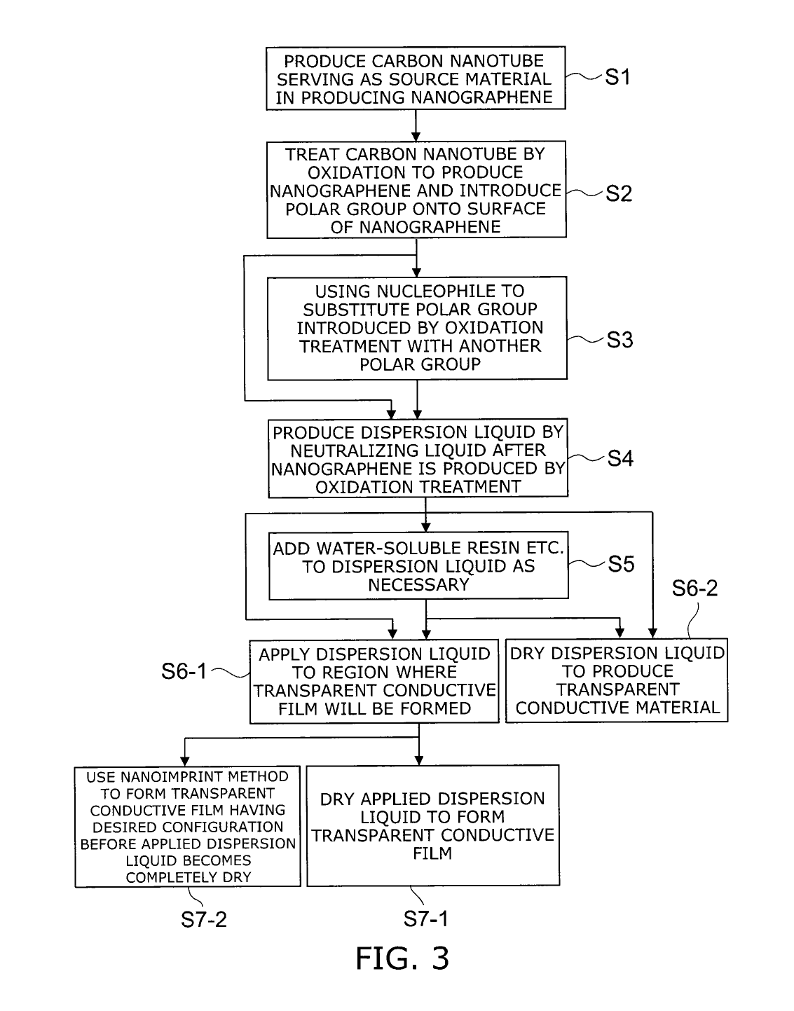

FIG. 3 is a flow chart for illustrating a method for manufacturing a transparent conductive material, a method for manufacturing a dispersion liquid, and a method for manufacturing a transparent conductive film according to the embodiment.

Here, nanographene is generally produced from graphite. However, producing nanographene from graphite causes complicated production processes, increased costs, etc.

Hence, in the method for manufacturing a transparent conductive material according to the embodiment, carbon nanotubes are produced and nanographene is produced from the produced carbon nanotubes.

First, carbon nanotunes serving as the source material in producing nanographene are produced (step S1).

Examples of the method for producing carbon nanotubes include the arc discharge method, the laser deposition method, the chemical vapor deposition (CVD) method, etc.

Thus, these production methods may be used to produce carbon nanotubes. However, it is difficult for these production methods to produce carbon nanotubes in a large amount. The arc discharge method and the laser deposition method can produce carbon nanotubes of good crystallinity, whereas it may be difficult for chemical vapor deposition to produce carbon nanotubes of good crystallinity.

In view of this, in the method for manufacturing a transparent conductive material according to the embodiment, the method illustrated below is used to produce carbon nanotubes.

In the production of carbon nanotubes, first, hydrocarbon is supplied into a reducing atmosphere (into an atmosphere filled with a reducing gas) in which a heated catalyst is provided and carbon nanotubes are produced on the catalyst.

The catalyst may be a flat plate made of a metal, for example. The metal may be, for example, one including iron such as carbon steel and stainless steel. By removing an oxide film formed on the surface of the catalyst, the activity as a catalyst can be improved.

Using a flat plate facilitates the scraping off of carbon nanotubes described later.

The temperature of the catalyst may be, for example, not less than 600° C. and not more than 750° C.

The hydrocarbon may be, for example, ethanol, ethylene, propane, methane, carbon monoxide, benzene, or the like.

It is also possible to supply hydrocarbon heated beforehand at approximately 350° C. into a reducing atmosphere.

The hydrocarbon supplied into the reducing atmosphere is pyrolyzed. By the hydrocarbon being pyrolyzed, carbon atoms adhere onto the catalyst. When carbon atoms attached onto the catalyst have reached the saturation state, carbon grows in a crystal form to produce carbon nanotubes.

Next, the carbon nanotubes produced on the catalyst are scraped off mechanically.

By repeating the production and scraping off of carbon nanotubes, carbon nanotubes of good crystallinity can be easily produced in a large amount.

Next, the carbon nanotubes are treated by oxidation, and thus nanographene is produced and polar groups are introduced onto the surface of the nanographene (step S2).

By treating the carbon nanotubes by oxidation, the carbon nanotubes are broken up to produce nanographene. In addition, by performing oxidation treatment, polar groups are introduced onto the surface of the nanographene.

As the oxidation treatment, for example, a treatment using sulfuric acid and a catalyst such as potassium permanganate, a treatment using a mixed acid solution in which sulfuric acid and nitric acid are mixed, and the like may be illustrated.

In the case where a mixed acid solution in which sulfuric acid and nitric acid are mixed is used for the oxidation treatment, the concentration of nitric acid may be set to 10 wt % or more. If the concentration of nitric acid is less than 10 wt %, the efficiency of introducing polar groups may be reduced.

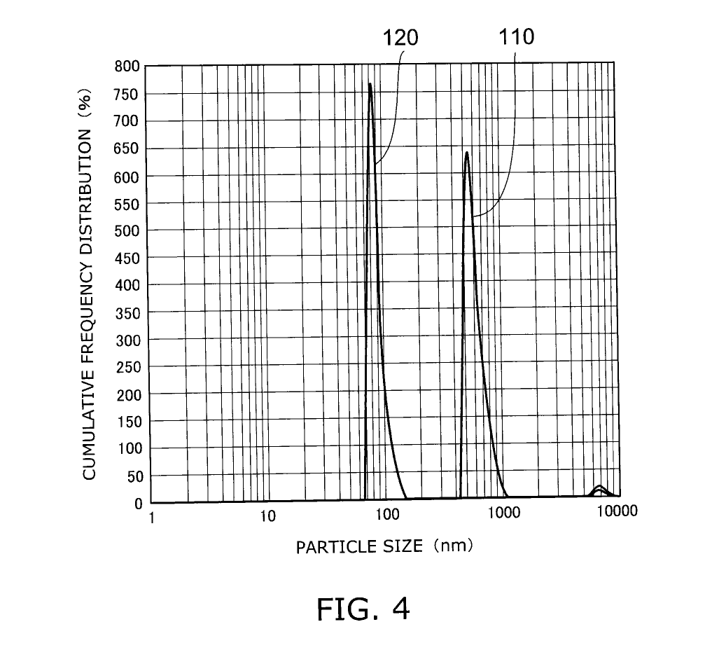

FIG. 4 is a graph for illustrating the production of nanographene by oxidation treatment.

“110” in FIG. 4 shows the particle size distribution in a liquid before carbon nanotubes are treated by oxidation, and “120” shows the particle size distribution in a liquid after carbon nanotubes are treated by oxidation.

FIG. 4 shows the measurement results of the particle size distribution in a liquid produced in the example described later. The particle size distribution in the liquids was measured using the zeta potential and particle size distribution measurement apparatus ELSZ-2 manufactured by Otsuka Electronics Co., Ltd.

As shown in FIG. 4, by treating carbon nanotubes by oxidation, nanographene of less than 100 nm can be produced.

The length of nanographene in this case is the maximum length in the tree-dimensional dimensions (e.g. the cross-sectional dimensions and length). For example, when the length is at a maximum out of the dimensions of the portions of nanographene, nanographene with a length of less than 100 nm can be produced.

A nucleophile may be used to substitute the polar group introduced by oxidation treatment with another polar group, as necessary (step S3).

For example, a nitro group introduced by oxidation treatment is substituted with an amino group, a hydroxyl group, a mercapto group, an organic amino group, an alkoxy group, a cyano group, a nitromethyl group, a bis(alkoxycarbonyl)methyl group, or the like.

As the substitution using a nucleophile, for example, the case may be illustrated where a nitro group is reduced using tin (Sn), which is a nucleophile, and concentrated hydrochloric acid and is substituted with an amino group or the like.

Next, the liquid after nanographene is produced by oxidation treatment is neutralized to produce a dispersion liquid (step S4).

The liquid after nanographene is produced by oxidation treatment has become acid. This liquid may be used as a dispersion liquid, but it may cause corrosion etc. depending on the object to which the dispersion liquid is applied. Hence, it is preferable to neutralize the liquid after nanographene is produced by oxidation treatment and make the liquid neutral.

Here, the neutralization can be performed by adding an alkaline agent. However, if an alkaline agent is added, the polar group introduced onto the surface of nanographene may change.

In view of this, in the embodiment, the neutralization is performed by putting an anion exchange resin (a basic resin) into the liquid after nanographene is produced by oxidation treatment.

In this case, filtration etc. is performed after the neutralization to remove the anion exchange resin.

To protect the anion exchange resin, water or the like may be added for dilution.

Next, a water-soluble resin etc. may be added to the dispersion liquid as necessary (step S5).

For example, a water-soluble resin with a visible light transmittance of 80% or more may be added. The water-soluble resin added may be a nonionic water-soluble resin in order to prevent the polar group introduced into nanographene from changing. As the nonionic water-soluble resin with a visible light transmittance of 80% or more, for example, poly(ethylene oxide) and the like may be illustrated.

Thus, a medium and nanographene having a polar group at its surface are included in the dispersion liquid. A water-soluble resin such as poly(ethylene oxide) may be further included.

In the medium included in the dispersion liquid, water included in the sulfuric acid solution and/or the nitric acid solution used for oxidation treatment, water produced by neutralization using an anion exchange resin, water added during dilution, and the like are included.

Next, the dispersion liquid is applied to the region where a transparent conductive film will be formed (step S6-1).

The application of the dispersion liquid can be performed using, for example, the screen printing method, the bar coater printing method, the spin coating method, or the like.

It is also possible to dry the dispersion liquid to produce a transparent conductive material (step S6-2).

When a transparent conductive material is produced by drying the dispersion liquid, storage and transfer become easy. When the transparent conductive material produced by drying the dispersion liquid is added to a medium such as water, a dispersion liquid can be easily produced.

When the transparent conductive material produced by drying the dispersion liquid is processed into a powder form, storage and transfer become even easier. Furthermore, it becomes even easier to disperse the transparent conductive material in a medium such as water.

Next, the applied dispersion liquid is dried to form a transparent conductive film (step S7-1).

The drying of the applied dispersion liquid may be, for example, natural drying, drying by heating, etc.

Before the applied dispersion liquid becomes completely dry, the nanoimprint method may be used to form a transparent conductive film having a desired configuration (step S7-2).

In this case, the formation using the nanoimprint method may be performed immediately after the application of the dispersion liquid, or may be performed when the applied dispersion liquid is in a semidry state.

In the case where the transparent conductive film is formed of ITO (indium tin oxide) or the like, the transparent conductive film needs to be formed using the photolithography method, the dry etching method, etc. This causes complicated formation processes for the transparent conductive film, increased costs, etc. In contrast, by the embodiment, a transparent conductive film having a desired configuration can be easily obtained.

### Example

Next, an example is illustrated.

First, the production of carbon nanotubes serving as the source material in producing nanographene is illustrated.

Ethanol was supplied into a reducing atmosphere in which a flat iron plate heated at 670° C. was provided. The ethanol had been heated at approximately 350° C. beforehand. The supplied ethanol is pyrolyzed to produce carbon nanotubes on the flat iron plate. The carbon nanotubes produced on the flat iron plate were mechanically scraped together to obtain carbon nanotubes serving as the source material.

Next, the carbon nanotubes thus obtained were used to manufacture a transparent conductive material, a dispersion liquid, and a transparent conductive film.

First, the carbon nanotubes were put into a mixed acid solution, and heating and stirring were performed to treat the carbon nanotubes by oxidation.

The mixed acid solution was a solution in which sulfuric acid and nitric acid were mixed at a ratio of 1:4. The amount of the mixed acid solution was 100 ml.

The amount of carbon nanotubes was 1 gw.

The heating and stirring were performed on a hot plate.

The heating temperature was set to 200° C., and the stirring rotation rate was set to 300 rpm. The heating and stirring were performed for 6 hours.

By performing the above oxidation treatment, the carbon nanotubes were broken up to produce nanographene and polar groups were introduced onto the surface of the nanographene.

FIG. 4 described above shows the measurement results of the particle size distribution in the liquid before performing oxidation treatment and the particle size distribution in the liquid after performing oxidation treatment.

As shown in FIG. 4, when carbon nanotubes are treated by oxidation, nanographene of less than 100 nm can be produced.

A measurement by FT-IR (Fourier transform infrared spectroscopy) has revealed that at least an amino group, a hydroxyl group, a mercapto group, an organic amino group, an alkoxy group, a cyano group, a nitromethyl group, and a bis(alkoxycarbonyl)methyl group have been introduced onto the surface of the nanographene.

Next, the liquid after nanographene was produced by oxidation treatment was cooled, then water was added to dilute the liquid approximately 20 times, and an anion exchange resin was put in to neutralize the liquid to neutrality.

After that, filtration etc. were performed to remove the anion exchange resin; thus, a dispersion liquid was produced.

When dilution with water is performed, a temperature increase due to the reaction heat can be suppressed and therefore the anion exchange resin can be protected.

Furthermore, when dilution with water is performed, the concentration of sulfuric acid and nitric acid in the liquid can be reduced and therefore the anion exchange resin can be protected.

Next, a solution in which poly(ethylene oxide) was dissolved was added to the dispersion liquid.

This process was performed such that the ratio of nanographene and poly(ethylene oxide) in the dispersion liquid to which the solution with poly(ethylene oxide) dissolved was added became 1:19.

Then, the dispersion liquid to which the solution with poly(ethylene oxide) dissolved was added was applied onto a glass substrate using the bar coater method. The workpiece was dried by heating; thus, a transparent conductive film was produced.

FIG. 1 shows the measurement results of the visible light transmittance of the transparent conductive film. FIG. 2B shows the measurement results of the surface electric resistance value of the transparent conductive film.

As shown in FIG. 1, the transparent conductive film according to the embodiment can make the visible light transmittance higher than the transparent conductive film including carbon nanotubes.

As shown in FIGS. 2A and 2B, the transparent conductive film according to the embodiment can make the surface electric resistance value lower than the transparent conductive film including carbon nanotubes.

The embodiments illustrated above can provide a transparent conductive material, a dispersion liquid, and a transparent conductive film that can improve transparency and conductivity and methods for manufacturing the same.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A transparent conductive material used for a transparent conductive film and comprising nanographene having a polar group at a surface of the nanographene.

2. The transparent conductive material according to claim 1, wherein the polar group is at least one selected from the group consisting of a hydroxy group, a methyl group, an aldehyde group, a carboxyl group, a nitro group, an amino group, a hydroxyl group, a mercapto group, an organic amino group, an alkoxy group, a cyano group, a nitromethyl group, and a bis(alkoxycarbonyl)methyl group.

3. The transparent conductive material according to claim 1, further including a nonionic water-soluble resin with a visible light transmittance of 80% or more.

4. The transparent conductive material according to claim 1, further including poly(ethylene oxide).

5. A dispersion liquid comprising:
a solvent; and
a transparent conductive material used for a transparent conductive film and including nanographene having a polar group at a surface of the nanographene.

6. The dispersion liquid according to claim 5, further including a nonionic water-soluble resin with a visible light transmittance of 80% or more.

7. A transparent conductive film comprising a transparent conductive material used for a transparent conductive film and including nanographene having a polar group at a surface of the nanographene.

8. The transparent conductive film according to claim 7, wherein the polar group is at least one selected from the group consisting of a hydroxy group, a methyl group, an aldehyde group, a carboxyl group, a nitro group, an amino group, a hydroxyl group, a mercapto group, an organic amino group, an alkoxy group, a cyano group, a nitromethyl group, and a bis(alkoxycarbonyl)methyl group.

9. The transparent conductive film according to claim 7, further including a nonionic water-soluble resin with a visible light transmittance of 80% or more.

10. The transparent conductive film according to claim 7, further including poly(ethylene oxide).

11. A method for manufacturing a dispersion liquid comprising:
supplying hydrocarbon into a reducing atmosphere provided with a heated catalyst and producing a carbon nanotube on the catalyst;
treating the carbon nanotube by oxidation to produce nanographene and introduce a first polar group onto a surface of the nanographene; and
producing a dispersion liquid by neutralizing a liquid after production of nanographene by the oxidation treatment.

12. The method according to claim 11, wherein the oxidation treatment is performed using at least sulfuric acid.

13. The method according to claim 11, wherein the neutralization is performed using an anion exchange resin.

14. The method according to claim 11, further comprising substituting the first polar group with a second polar group using a nucleophile.

15. The method according to claim 11, further comprising adding a nonionic water-soluble resin with a visible light transmittance of 80% or more.

16. A method for manufacturing a transparent conductive material comprising:
manufacturing a dispersion liquid using a method for manufacturing a dispersion liquid including:
supplying hydrocarbon into a reducing atmosphere provided with a heated catalyst and producing a carbon nanotube on the catalyst;
treating the carbon nanotube by oxidation to produce nanographene and introduce a first polar group onto a surface of the nanographene; and
producing a dispersion liquid by neutralizing a liquid after production of nanographene by the oxidation treatment; and
drying the dispersion liquid.

17. The method according to claim 16, further comprising substituting the first polar group with a second polar group using a nucleophile.

18. The method according to claim 16, further comprising adding a nonionic water-soluble resin with a visible light transmittance of 80% or more.

19. A method for manufacturing a transparent conductive film comprising:
manufacturing a dispersion liquid using a method for manufacturing a dispersion liquid including:
supplying hydrocarbon into a reducing atmosphere provided with a heated catalyst and producing a carbon nanotube on the catalyst;
treating the carbon nanotube by oxidation to produce nanographene and introduce a first polar group onto a surface of the nanographene; and
producing a dispersion liquid by neutralizing a liquid after production of nanographene by the oxidation treatment;
applying the dispersion liquid to a region for forming a transparent conductive film; and
drying the applied dispersion liquid.

20. The method according to claim 19, further comprising using a nanoimprint method to form a transparent conductive film having a desired configuration before the applied dispersion liquid becomes completely dry.
